(19) United States
(12) Patent Application Publication
(10) Pub. No.: US 2010/0002888 A1
(43) Pub. Date: Jan. 7, 2010

(54) Method and device for low-delay joint-stereo coding

(76) Inventors: Hauke Kruger, Aachen (DE); Peter Vary, Aachen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/499,250

(22) Filed: Jul. 8, 2009

Related U.S. Application Data
(60) Provisional application No. 61/078,922, filed on Jul. 8, 2008.

(30) Foreign Application Priority Data
Jul. 6, 2008 (EP) 08012311.0

(51) Int. Cl. H04R 5/00; H04R 25/00

(52) U.S. Cl. 381/23.1; 381/1

(57) ABSTRACT

In one aspect a coding of stereophonic audio signals based on inter-channel linear prediction is provided. Each of the two channels is predicted by filtering the center stereo image of both the channels. Optimal filter coefficients are calculated for both channels is a generalization of Mid/Side and Left/Right joint-stereo coding.

The present invention relates to a method and a device for encoding stereophonic audio signals based on linear prediction. Moreover, the present invention relates to a method for communicating stereophonic audio signals and respective devices for encoding, transmitting and decoding. The invention is also suitable to extend any existing monaural speech or audio codec towards stereo functionality. Specifically, the present invention relates to microphones and hearing aids employing such methods and devices.

### BACKGROUND

In the present document reference will be made to the following documents:

[1] A. Biswas and A. C. den Brinker. Stability of the Stereo Linear Prediction Schemes. 47th International Symposium EL-March 2005, Zadar, Croatia, June 2005,

[2] J. Breebaart and C. Faller. Spatial Audio Processing. John Wiley, 2007,

[3] E. Torick and T. Keller. Improving the signal to noise ratio and coverage of FM stereo broadcasts. AES Journal, 33(12), dec,

[4] H. Fuchs. Improving Joint Stereo Audio Coding by Adaptive Inter-Channel Prediction. IEEE Workshop on Applications of Signal Processing to Audio and Acoustics, 1993,

[5] J. Herre, K. Brandenburg, and D. Lederer. Intensity Stereo Coding. AES 96th Convention, pages 1-10, February 1994.

[6] http://www.answers.com/topic/fm broadcasting. FM broadcasting, 2007,

[7] J. D. Johnston and A. J. Ferreira. Sum-Difference Stereo transform Coding. Proc. of IEEE International Conference on Acoustics, Speech, and Signal Processing 1992, San Francisco, USA, 1992,

[8] T. Liebchen. Lossless Audio Coding Using Adaptive Multichannel Prediction. 113th Convention of the Audio Engineering Society (AES), Los Angeles, USA, 2002,

[9] Standard ISO/IEC 11172-3:1993. Information Technology—Coding of Moving Pictures and associated Audio for Digital Storage at up to about 1.5 Mbit/s—Part 3: Audio, 1993.

### INTRODUCTION

In the history of stereo audio transmission, in Frequency Modulated (FM) radio, broadcasting of stereophonic signals started already in 1961. The basis for FM stereo broadcasting is the production of a mid and a side channel signal (M/S stereo) from the left and right channel signals. In each modulated FM radio channel, the mid channel signal is transmitted in the baseband spectrum and the side channel signal in the spectrum related to the amplitude modulated double-sideband suppressed carrier signal (DSSCS) [6] [3]. Still nowadays, FM radio receivers may reconstruct either only the monaural mid channel representation (mono) of the input stereo signal from only the baseband spectrum, or the complete stereo image signal if also the DSSCS signal is demodulated.

In digital audio compression, a lot of confusion is related to the term “joint-stereo coding”. In the literature, it is referred to as both, M/S and Intensity Stereo coding. The target of joint-stereo coding is to enable a higher compression ratio in a joint coding approach in comparison to an approach in which the signals for left and right channel are coded independently.

A lot of joint-stereo approaches in the literature are based on a high resolution frequency domain representation of the input signal (e.g. Intensity Stereo Coding, [2], [5]) and therefore related to a high algorithmic delay. In contrast to these techniques, joint-stereo coding approaches in the time domain better achieve low algorithmic delay. In [4], an adaptive inter-channel predictor is proposed that is composed of an inter-channel FIR prediction filter and a delay. Predictor filter coefficients and inter-channel delay adapt to the given signals for left and right channel. The target of this approach is to produce an estimate of the first channel on the basis of the second channel to reduce the signal variance of the predicted channel and hence save bits. Adaptive multichannel prediction is also investigated in [8] and revisited in [1]. In this case, inter- and intra-channel predictors are optimized in a joint way to produce residual signals with reduced signal variance in both channels to reduce the overall bit rate for lossless coding. Both techniques are not suitable to extend existing mono codecs in a hierarchical way.

EP 1 876 585 A1 discloses an audio encoding device capable of encoding stereo audio in audio encoding having monaural-stereo scalable configuration. In an inter-channel predicting section a predicting signal is derived from a monaural signal by adaptive delaying and gaining.

EP 1 953 736 A1 discloses a stereo encoding device and a stereo signal predicting method. A prediction unit predicts a prediction signal from a mono signal and outputs a prediction parameter composed of a delay time difference and an amplitude ratio.

Invention

It is the object of the present invention to provide a method and a device for encoding stereo audio data having low delay of the algorithm and which are able to extend mono codecs in a hierarchical way.

According to the present invention the above object is solved by a method for encoding stereo signals comprising a first signal and a second signal,
calculating a mono signal as the mean of said first and said second signal,
calculating a first estimation signal and a second estimation signal by filtering said mono signal with a first filter and a second filter, respectively,
calculating a first residual signal and a second residual signal as the difference between said first signal and said first estimation signal and said second signal and said second estimation signal, respectively.

Mathematical considerations result in equation (18) which postulates that one estimation signal is sufficient.

Moreover, said first signal is the right channel signal of a stereo audio signal and said second signal is the left channel signal of the stereo audio signal.

According to a further preferred embodiment sets of coefficients of said first and said second filter and the first and said second residual signal are quantized.

Preferably, at least one said set of coefficients are optimized by minimizing the expected value (mathematical expectation) of squared said first and/or said second residual signal, respectively.

In a further embodiment said first and/or said second filter is a symmetric linear finite impulse response (FIR) filter.

Advantageously, the delay introduced by said first and/or said second filter is compensated by delaying said first and/or said second signal by N samples whereas N+1 is the number of filter coefficients.

Furthermore, there is provided a method for communicating stereo signals consisting of a first signal and a second signal,
generating said stereo signals in a first audio device,
encoding said stereo signals in said first audio device according to the method of one of the claims 1 to 5,
transmitting the encoded stereo signals from said first audio device to a second audio device, and
decoding the encoded stereo signal in said second audio device.

Furthermore, there is provided a device for encoding stereo signals with a first signal and a second signal, comprising:
calculation means for calculating a mono signal as the mean of said first and said second signal,
estimation means for calculating a first estimation signal and/or a second estimation signal by filtering said mono signal with a first filter and/or a second filter, respectively,
summing means for calculating a first residual signal and/or a second residual signal as the difference between said first signal and said first estimation signal and/or said second signal and said second estimation signal, respectively

According to a preferred embodiment, the device comprises quantizing means for quantizing the sets of coefficients of said first and/or said second filter and the first and/or said second residual signal.

Moreover, at least one said set of coefficients are optimized by minimizing the expected value (mathematical expectation) of squared said first and/or said second residual signal, respectively.

Preferably, said first and/or said second filter is a symmetric linear finite impulse response (FIR) filter.

Furthermore, the device comprises delay means for compensating the delay introduced by said first and/or said second filter by delaying said first and/or said second signal by N samples whereas N+1 is the number of filter coefficients.

Furthermore, there is provided a Stereo Signal System comprising a first and a second stereo signal device, whereas said first stereo signal device includes a device for encoding stereo signals according to the present invention and transmitting means for transmitting the encoded stereo signals to the second stereo device, and whereas said second stereo signal device includes decoding means for decoding the encoded stereo signal received from the first stereo signal device.

Finally, there is provided a hearing aid comprising one or more devices according to the present invention.

Since the present invention is based on a time domain representation of the signals, the invention is well suited for stereo coding with low algorithmic delay. Due to its modularity it is also suitable to extend any existing monaural speech or audio codec towards stereo functionality while preserving backwards compatible with monaural transmission.

The above described methods and devices are preferably employed for the wireless transmission of audio signals between a microphone and a receiving device or a communication between hearing aids. However, the present application is not limited to such use only. The described methods and devices can rather be utilized in connection with other audio devices like headsets, headphones, wireless microphones, etc. and as well for data storage.

### DRAWINGS

More specialties and benefits of the present invention are explained in more detail by means of schematic drawings showing in:

FIG. 1: the principle structure of a hearing aid,

FIG. 2: an audio system including a headphone or earphone receiving signals from a microphone or another audio device,

FIG. 3: a block diagram of the principle of Mid/Side Stereo Coding in FM Radio,

FIG. 4: a block diagram of the principle for Stereo Coding according to the invention and

FIG. 5: a further block diagram of the principle for Stereo Coding according to the invention.

### EXEMPLARY EMBODIMENTS

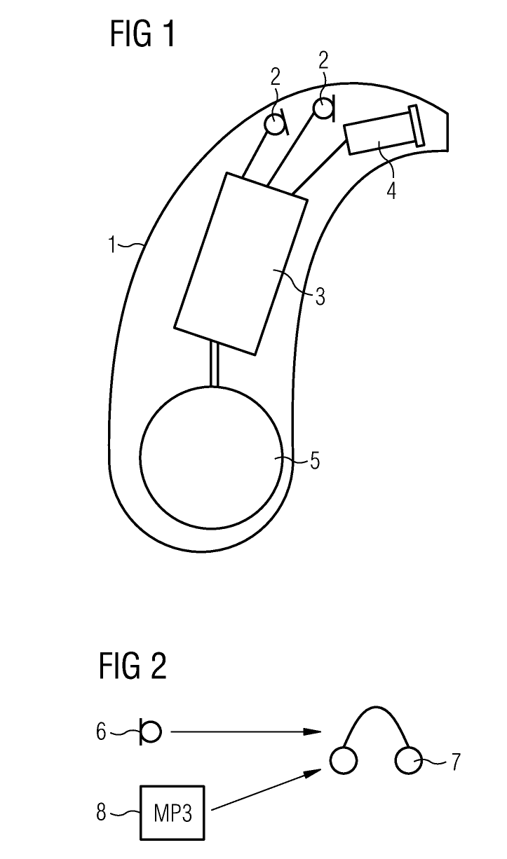

Since the present application is preferably applicable to hearing aids, such devices shall be briefly introduced in the next two paragraphs together with FIG. 1.

Hearing aids are wearable hearing devices used for supplying hearing impaired persons. In order to comply with the numerous individual needs, different types of hearing aids, like behind-the-ear hearing aids and in-the-ear hearing aids, e.g. concha hearing aids or hearing aids completely in the canal, are provided. The hearing aids listed above as examples are worn at or behind the external ear or within the auditory canal. Furthermore, the market also provides bone conduction hearing aids, implantable or vibrotactile hearing aids. In these cases the affected hearing is stimulated either mechanically or electrically.

In principle, hearing aids have an input transducer, an amplifier and an output transducer as essential component. The input transducer usually is an acoustic receiver, e.g. a microphone, and/or an electromagnetic receiver, e.g. an induction coil. The output transducer normally is an electro-acoustic transducer like a miniature speaker or an electro-mechanical transducer like a bone conduction transducer. The amplifier usually is integrated into a signal processing unit. Such principle structure is shown in FIG. 1 for the example of a behind-the-ear hearing aid. One or more microphones 2 for receiving sound from the surroundings are installed in a hearing aid housing 1 for wearing behind the ear. A signal processing unit 3 being also installed in the hearing aid housing 1 processes and amplifies the signals from the microphone. The output signal of the signal processing unit 3 is transmitted to a receiver 4 for outputting an acoustical signal. Optionally, the sound will be transmitted to the ear drum of the hearing aid user via a sound tube fixed with an otoplasty in the auditory canal. The hearing aid and specifically the signal processing unit 3 are supplied with electrical power by a battery 5 also installed in the hearing aid housing 1.

This stereo-coding concept according to the invention can also be used for audio devices as shown in FIG. 2. For example the signal of an external stereo-microphone 6 has to be transmitted to a headphone or earphone 7. Furthermore, the inventive coding concept may be used for any other audio transmission between audio devices like a TV-set or an MP3-player 8 and earphones 8 as also depicted in FIG. 2. Each of the devices 6 to 7 comprises encoding, transmitting and decoding means as far as the communication demands.

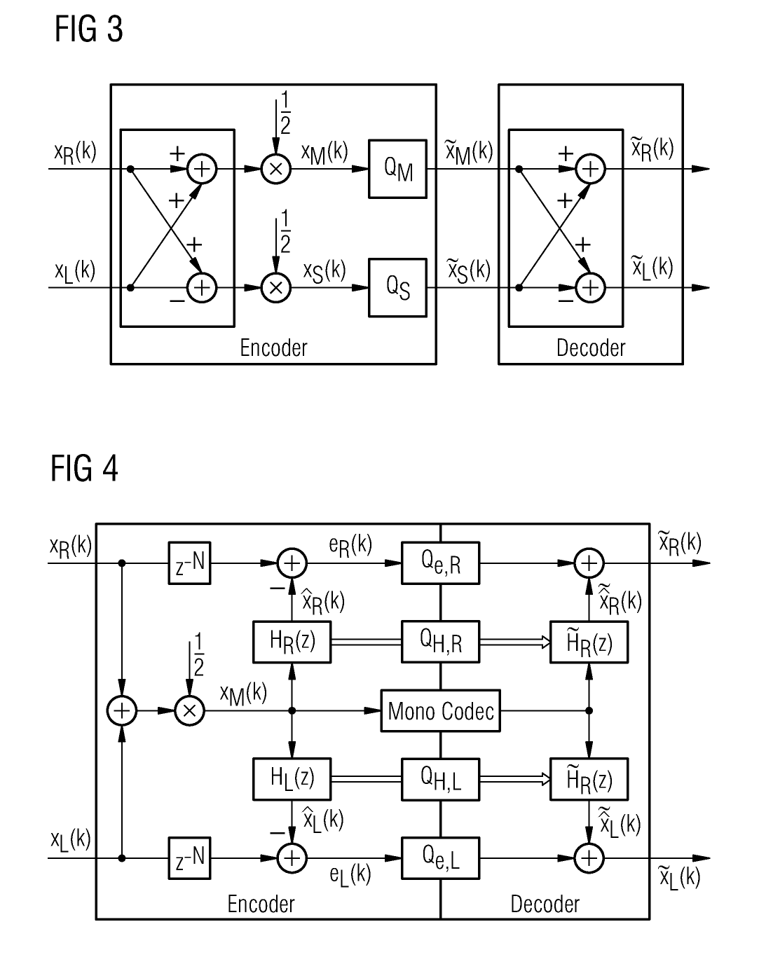

The principle of Mid/Side (M/S) joint-stereo coding is shown in FIG. 3. Given the discrete sample signals of the right and the left audio channel as x_{R}(k) and x_{L}(k) respectively, the mid and the side channel signals x_{M}(k) and x_{S}(k) are calculated in the encoder as

x_{M}(k)=(x_{R}(k)+x_{L}(k))/2 (1)

x_{S}(k)=(x_{R}(k)−x_{L}(k))/2. (2)

k is the sample number and k*T are the sample instants with T defined as the sampling interval related to the sampling frequency fₛ=1/T.

Both signals are quantized in independent quantizing units, Q_{M} and Q_{S} respectively, and transmitted to the decoder. The quantized left \tilde{x}_{L}(k) and right \tilde{x}_{R}(k) channel signals are reconstructed from the quantized versions of the mid \tilde{x}_{M}(k) and the side \tilde{x}_{S}(k) channel signal as

\tilde{x}_{R}(k)=\tilde{x}_{M}(k)+\tilde{x}_{S}(k) (3)

\tilde{x}_{L}(k)=\tilde{x}_{M}(k)−\tilde{x}_{S}(k). (4)

In a typical audio signal recording, often, a strong mid channel signal component is present so that the signal variance of x_{M}(k) is significantly higher than that of x_{S}(k) which can be exploited to reduce the overall bit rate compared to independent quantization of both channels. M/S joint-stereo coding is used in a fullband approach in FIG. 3 but can also be applied to subband signals produced by a filterbank [7].

In the presence of signals with a very dominant signal component in one channel, M/S coding does not provide any coding advantage. In this case, L/R joint-stereo coding achieves a bit rate reduction if more bit rate is allocated for the channel with the dominant signal component than for the other channel. Switching between M/S and L/R coding, however, must be signaled to the decoder.

The invention operates in the time domain to achieve low algorithmic delay and is shown in FIG. 4. From the right and the left channel input signal, in the first step a mono signal is calculated,

$${x}_{M} ( k ) = \frac{{x}_{R} ( k ) + {x}_{L} ( k )}{2} . \qquad ( 5 )$$

The signals \hat{x}_{L}(k) and \hat{x}_{R}(k) are produced as the estimate for the left and right channel input signals by means of linear filtering of the mono signal with system functions H_{L}(z) and H_{R}(z) respectively. The filters are for example symmetric linear phase FIR filters with (2*N+1) filter coefficients,

$${H}_{L} ( z ) = {a}_{L} ( 0 ) \cdot {z}^{- N} + {\sum }_{i = 1}^{N} {a}_{L} ( i ) \cdot ( {z}^{- N - i} + {z}^{- N + i} ) \\ {H}_{R} ( z ) = {a}_{R} ( 0 ) \cdot {z}^{- N} + {\sum }_{i = 1}^{N} {a}_{R} ( i ) \cdot ( {z}^{- N - i} + {z}^{- N + i} ) . \qquad ( 6 )$$

Other filters e.g. non-symmetric FIR filters or IIR filters can be used.

The stereo residual signals e_{L}(k) and e_{R}(k) are the difference between a delayed version of the input signals and the estimate signals \hat{x}_{L}(k) and \hat{x}_{R}(k),

$${e}_{L} ( k ) = {x}_{L} ( k - N ) - {a}_{L} ( 0 ) \cdot {x}_{M} ( k - N ) - {\sum }_{i = 1}^{N} {a}_{L} ( i ) \cdot ( {x}_{M} ( k - N - i ) + {x}_{M} ( k - N - i ) ) \\ {e}_{R} ( k ) = {x}_{R} ( k - N ) - {a}_{R} ( 0 ) \cdot {x}_{M} ( k - N ) - {\sum }_{i = 1}^{N} {a}_{R} ( i ) \cdot ( {x}_{M} ( k - N - i ) + {x}_{M} ( k - N + i ) ) . \qquad ( 7 )$$

Instead of filtering the estimate signals \hat{x}_{L}(k), \hat{x}_{R}(k), filtering of the residual signals e_{L}(k), e_{R}(k) is possible as well.

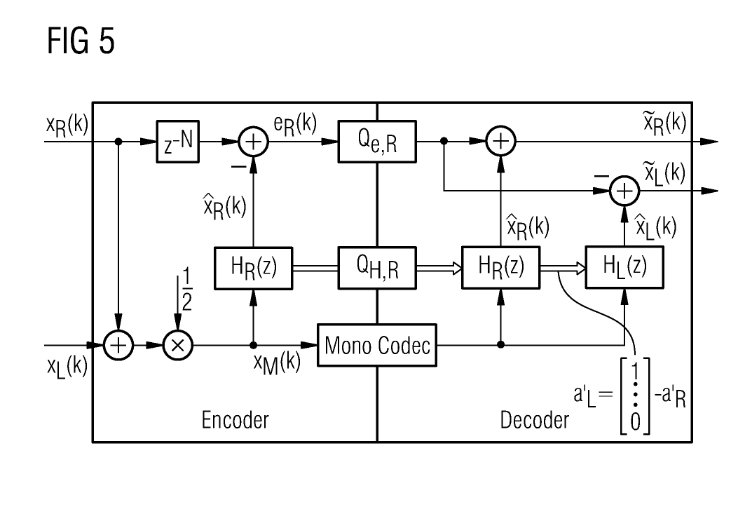

Delaying the input signals is required to compensate the delay introduced by the linear phase filters. For a reconstruction of the stereo signal in the decoder, in addition to the mono signal x_{M}(k), the two sets of (N+1) coefficients a_{L}(i) and a_{R}(i) and the residual signals e_{L}(k) and e_{R}(k) are quantized and transmitted. For this purpose, in FIG. 5, the blocks Q_{e,R}, Q_{H,R} for the right channel and Q_{e,L}, Q_{H,L} for the left channel are depicted.

For the calculation of the optimal filter coefficients a_{L}(i) and a_{R}(i), it is assumed that the signals x_{L}(k) and x_{R}(k) are stationary. At first only the right channel is considered. The target of the optimization procedure is to minimize the expectation of the squared residual signal e_{R}(k):

E{e_{R}²(k)}→min (8)

At first, the substitution

$${{a}_{R} ( i )}^{′} = \{ \begin{matrix}\frac{1}{2} \cdot {a}_{R} ( i ) & for i = 0 \\ {a}_{R} ( i ) & for i > 0\end{matrix} \qquad ( 9 )$$

is introduced for the following calculations. With equation (7) and setting its partial derivatives with respect to all a_{R}(i)′ zero, the following equation results:

X_{M}·a′_{R}=X_{R,M}. (10)

The vector

a′_{R}=[a_{R}(0)′ a_{R}(1)′ . . . a_{R}(N)′]^{T} (11)

contains the desired filter coefficients. The matrix

$${X}_{M} = [ \begin{matrix}{X}_{M} ( 0 , 0 ) & … & {X}_{M} ( 0 , N ) \\ … & {X}_{M} ( j , l ) & … \\ {X}_{M} ( N , 0 ) & … & {X}_{M} ( N , 2 \cdot N )\end{matrix} ] \qquad ( 12 )$$

is composed of the autocorrelation function values related to the mono signal x_{M}(k),

X_{M}(j,l)=φₓ_{_{M}}_{,x}_{_{M}}(|l−j|)+φₓ_{_{M}}_{,x}_{_{M}}(|l+j|) (13)

with the index l and j to address columns and rows respectively.

The vector X_{R,M} consists of the cross correlation function values,

$${X}_{R , M} = [ \begin{matrix}( \frac{{ϕ}_{{x}_{R} , {x}_{M}} ( 0 ) + {ϕ}_{{x}_{R} , {x}_{M}} ( - 0 )}{2} ) \\ ( \frac{{ϕ}_{{x}_{R} , {x}_{M}} ( 1 ) + {ϕ}_{{x}_{R} , {x}_{M}} ( - 1 )}{2} ) \\ … \\ ( \frac{{ϕ}_{{x}_{R} , {x}_{M}} ( N ) + {ϕ}_{{x}_{R} , {x}_{M}} ( - N )}{2} )\end{matrix} ] . \qquad ( 14 )$$

The optimal filter coefficients a′_{R} are hence

a′_{R}=(X_{M})⁻¹·X_{R,M} (15)

for the right channel signal. The filter coefficients for the left channel are determined in analogy to equations (10)-(15) as

a′_{L}=(X_{M})⁻¹·X_{L,M}. (16)

With the equations to determine the optimal filter coefficients and the relation

φₓ_{_{R}}_{,x}_{_{M}}(i)+φₓ_{_{L}}_{,x}_{_{M}}(i)=2·φₓ_{_{M}}_{,x}_{_{M}}(i), (17)

it can be shown that

$$\begin{matrix}{a}_{R}^{′} + {a}_{L}^{′} = {( {X}_{M} )}^{- 1} \cdot ( {X}_{R , M} + {X}_{L , M} ) \\ = {[ \begin{matrix}1 & 0 & … & 0\end{matrix} ]}^{T} ,\end{matrix} \qquad ( 18 )$$

and hence there is a very simple relation between the coefficients for the left and the right channel. In analogy to this, with (17) and (18), a simple relation can be derived for the residual signals for left and right channel as well,

e_{L}(k)+e_{R}(k)=0 ∀k. (19)

Considering this result, FIG. 4 can be transformed into the diagram shown in FIG. 5. According to the resulting joint-stereo coding block diagram, only the filter coefficients and the residual signal related to one channel (in the example the right channel) must be transmitted which reduces the required overall bit rate.

In the presence of a stereo signal where both channel signals are identical, x_{L}(k)=x_{R}(k), the optimal filter coefficients are

a_{R}=a_{L}=[1 0 . . . 0]^{T} (20)

so that the residual signal becomes

$${e}_{R} ( k ) = {x}_{R} ( k - N ) - \frac{{x}_{L} ( k - N ) + {x}_{R} ( k - N )}{2} = 0. \qquad ( 21 )$$

In this case, the system according to the invention is identical to M/S joint-stereo coding with the side channel signal identical to the stereo residual signal.

In the presence of a signal with a dominant signal in one channel only, e.g. x_{R}(k)=0, x_{L}(k)≠0 the resulting filter coefficients are

a_{R}=0 and a_{L}=[2 0 . . . 0]^{T} (22)

The residual signal becomes e_{R}(k)=e_{L}(k)=0 and the system is identical to L/R joint stereo coding with the side channel signal identical to the stereo residual signal. The invention is hence a generalization of M/S and L/R joint-stereo coding.

1.-14. (canceled)

15. A method for encoding stereo signals with a first signal and a second signal, comprising:
determining a mono signal as a mean of the first and the second signals;
filtering the mono signal by a linear filter to form an estimation signal; and
calculating a residual signal as the difference between the first signal and the estimation signal.

16. The method according to claim 15,
wherein the first signal is the right channel signal of a stereo audio signal and the second signal is the left channel signal of the stereo audio signal or
wherein the first signal is the left channel signal of a stereo audio signal and the second signal is the right channel signal of the stereo audio signal.

17. The method according to claim 15,
wherein a number of samples of the first and second signals thereby a plurality of mono signals are determined, a plurality of estimation signals are formed and a plurality of residual signals are calculated, further comprises:
quantizing a set of filter coefficients used to filter the plurality of mono signals; and/or
quantizing the plurality of residual signals.

18. The method according to claim 17, wherein the set of filter coefficients is optimized by minimizing the expected value of a square of the residual signal.

19. The method according to claim 15, wherein the linear filter is a symmetric linear finite impulse response filter.

20. The method according to claim 17, further comprising compensating a delay introduced by the linear filter by delaying the first signal by N samples, whereas N+1 defines how many filter coefficients are in the set.

21. The method according to claim 15, wherein the method is implemented by a hearing aid system.

22. A method for encoding stereo signals with a first signal and a second signal, comprising:
determining a mono signal as a mean of the first and the second signals;
filtering the mono signal by a first linear filter to form an first estimation signal;
calculating a first residual signal as the difference between the first signal and the first estimation signal;
filtering the mono signal by a second linear filter to form an second estimation signal; and
calculating a second residual signal as the difference between the second signal and the second estimation signal.

23. The method according to claim 22, wherein the first signal is the right channel signal of a stereo audio signal and the second signal is the left channel signal of the stereo audio signal.

24. The method according to claim 22,
wherein a number of samples of the first and second signals thereby a plurality of mono signals are determined, a plurality of first and second estimation signals are formed and a plurality of first and second residual signals are calculated, further comprises:
quantizing a set of filter coefficients used to filter the plurality of first mono signals; and/or
quantizing a set of filter coefficients used to filter the plurality of second mono signals; and/or
quantizing the plurality of first residual signals, and/or
quantizing the plurality of first residual signals.

25. The method according to claim 24, wherein at least one of the sets of coefficients is optimized by minimizing the expected value of squared the first and/or the second residual signal, respectively.

26. The method according to claim 22, wherein the first and/or the second filter is a symmetric linear finite impulse response filter.

27. The method according to claim 22, wherein a delay introduced by the first and/or the second filter is compensated by delaying the first and/or the second signal by N samples, whereas N+1 is the number of filter coefficients.

28. The method according to claim 22, wherein the method is implemented by a hearing aid system.

29. A device for encoding stereo signals with a first signal and a second signal, comprising:
calculation means that calculates a mono signal as the mean of the first and the second signal;
estimation means that calculates a first estimation signal and/or a second estimation signal by linear filtering the mono signal with a first filter and/or a second filter, respectively; and
summing means for calculating a first residual signal and/or a second residual signal as a difference between the first signal and the first estimation signal and/or the second signal and the second estimation signal, respectively.

30. The device according to claim 29, further comprises quantizing means for quantizing sets of coefficients of the first and/or the second filter and the first and/or the second residual signal.

31. The device according to claim 30, whereas at least one the sets of coefficients are optimized by minimizing the expected value; mathematical expectation of squared the first and/or the second residual signal, respectively.

32. The device according to claim 29, wherein the first and/or the second filter is a symmetric linear finite impulse response filter.

33. The device according to claim 30, comprising a delay means for compensating the delay introduced by the first and/or the second filter by delaying the first and/or the second signal by N samples whereas N+1 is the number of filter coefficients.
